(19) United States
(12) Patent Application Publication
(10) Pub. No.: US 2016/0332891 A1
(43) Pub. Date: Nov. 17, 2016

(54) METHOD AND SYSTEM FOR PURIFYING PRODUCED WATER

(71) Applicant: New Mexico Technical Research Foundation, Socorro, NM (US)

(72) Inventor: Robert Balch, Socorro, NM (US)

(21) Appl. No.: 14/713,984

(22) Filed: May 15, 2015

(51) Int. Cl. C02F 1/04; B01D 3/00

(52) U.S. Cl. CPC C02F 1/043; B01D 3/00; C02F 2101/32

(57) ABSTRACT

A method and system of cleaning or purifying produced water, especially from a well head, using a humidification/dehumidification unit comprised of at least one humidification chamber portion capable of receiving hot produced water and, in a counter current direction, air; and at least one dehumidification/condensation chamber portion capable of receiving humid air from the humidification chamber portion. Concentrated produced water is capable of being withdrawn from the humidification chamber portion, and clean or purified water is capable of being withdrawn from the dehumidification/condensation chamber portion.

### BACKGROUND OF THE INVENTION

The present invention relates to a method and system for purifying produced water, especially from a wellhead.

Conventional oil/water separations and filtration processes deployed in, for example, the oil/gas industry, can only remove floating particulates and large oil droplets. Advanced demineralization technologies are then required in order to remove the salt and dissolved organics, in order to meet surface water discharge standards. Current desalination technologies for ion removal from sea water focus on membrane separation and thermal separation. Membrane-based desalination processes, such as reverse osmosis and electro dialysis are not cost or process-efficient for small or medium scale water desalination, for example in the neighborhood of less than 1,000 m³ per day. Furthermore, dissolved organics and the high concentration of suspended particulates in produced water seriously reduce the lifetime of the membranes that are utilized due to fouling. Therefore, sophisticated pretreatment is generally required to remove the floating particulates, dissolved metal ions and organics in order to prolong the lifetime of the membranes. Heat-based desalination methods, such as multi-stage flash desalination, multiple-effect evaporation with thermal vapor compression and mechanical vapor compression, are energy-intensive due to the high heat consumption during phase conversion, and are expensive to operate on a small scale. Other desalination methods such as freeze/thaw deionization can be used only in cold weather. Moreover, sophisticated pretreatment is generally required for prolonged operations for these technologies. Dissolved organics, metal oxides, and a large variation in salt concentration are the main factors in limiting the deployment of conventional desalination technologies for the purification or the cleaning of produced water at less than massive scales.

Therefore, there is a real need for being able to provide clean water for smaller scale operations in a cost-effective manner.

### BRIEF DESCRIPTION OF THE DRAWINGS

This need is realized by the method and system of the present application, which will be described subsequently with the aid of the accompanying schematic drawings, in which:

FIG. 1 diagrammatically illustrates the method and system of the present application;

FIG. 2 shows the cleaning or purifying portion of the system of FIG. 1, with the humidification/dehumidification unit being shown as a top view, with the lid removed;

FIG. 3 is an enlarged view of the encircled portion A-A of FIG. 1; and

FIGS. 4a and 4b schematically illustrate the humidification and dehumidification chamber portions respectively of Applicant's humidification/dehumidification unit.

### SUMMARY OF THE INVENTION

The method of the present application for purifying produced water includes the steps of providing produced water at a temperature of from 140 to 212° F.; conveying the hot water through the at least one humidification chamber portion; conveying ambient air through the at least one humidification chamber portion countercurrent to the direction of conveyance of the hot water therethrough to produce an up to 99% humid atmosphere in the humidification chamber portion, wherein concentrated produced water is also produced in the humidification chamber portion; withdrawing the concentrated produced water from the humidification chamber portion; conveying the humid air to at least one dehumidification/condensation chamber portion; allowing the humid air to cool in the dehumidification/condensation chamber portion, wherein fresh water is condensed out; and collecting the fresh water.

Applicant's system for purifying produced water comprises a humidification/dehumidification unit comprised of at least one humidification chamber portion capable of receiving hot produced water and, in a countercurrent direction, air; and at least one dehumidification/condensation chamber portion capable of receiving humid air from the humidification chamber portion, wherein concentrated produced water is capable of being withdrawn from the humidification chamber portion and clean or purified water is capable of being withdrawn from the dehumidification/condensation chamber portion.

Among other advantages Applicant's method and system for purifying or cleaning produced water provides flexibility in the capacity of produced water that can be processed, operation at atmospheric pressure, and the use of low cost process energy, for example in the form of solar, geothermal, and industry waste heat. Another advantage is that Applicant's process can be carried out below the boiling point of the liquid, unlike other typical thermal processes where extensive energy is used in heating and vaporizing water.

### DETAILED DESCRIPTION OF SPECIFIC EMBODIMENTS

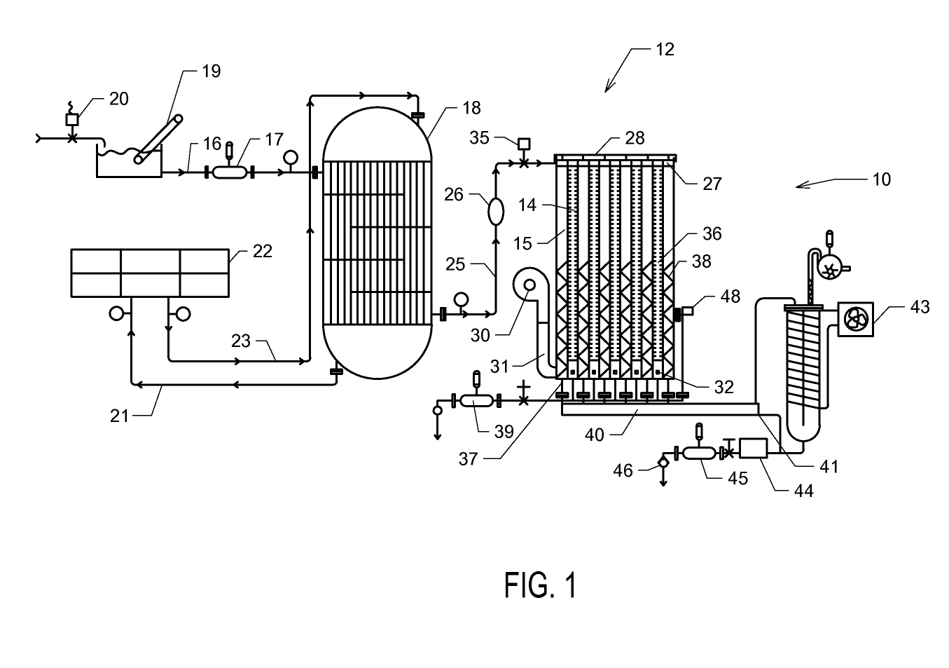

The method and system of the present application for purifying produced water will now be described in conjunction with FIGS. 1-4.

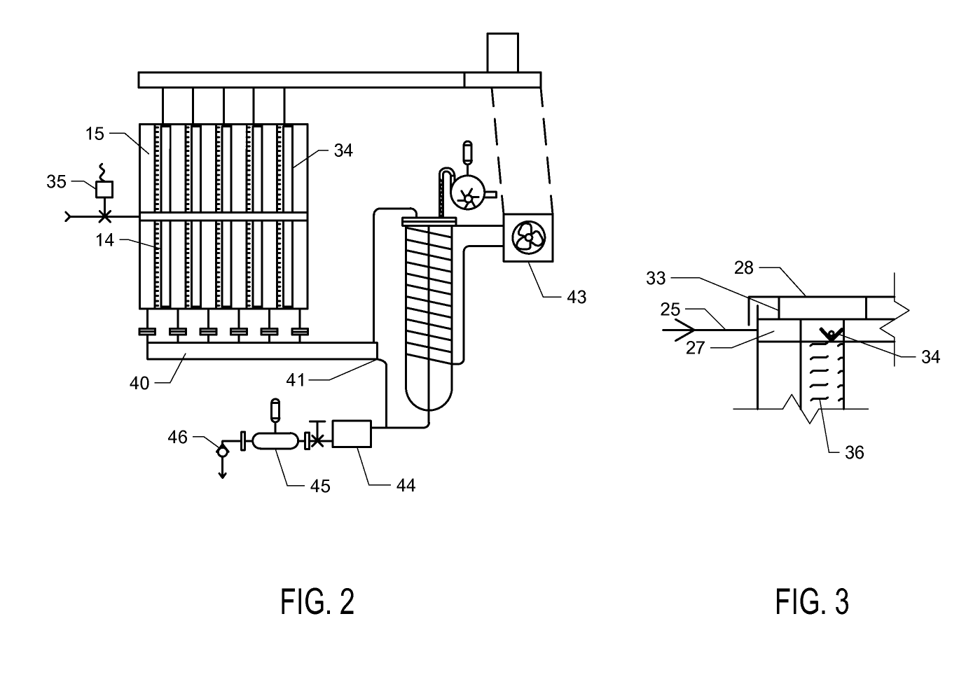

FIG. 1 illustrates one exemplary embodiment of an overall system for practicing Applicant's inventive method of cleaning or purifying produced water, with various details of the purifying portion of the system being shown in greater detail in FIGS. 2-4. Applicant's overall system is designated generally by the reference numeral 10 in FIG. 1, with the major components of the system 10 being the humidification/dehumidification unit 12, which is composed of at least one humidification chamber portion 14 and at least on dehumidification or condensation chamber 15.

In the illustrated embodiment of Applicant's system 10, produced water, for example from a wellhead, is conveyed via the line 16, with the aid of the transfer pump 17, to the holding tank 18. An oil skimmer 19, such as a belt-type skimmer, may be disposed in the line 16 to remove any surface oil that remains in the produced water. Other separation devices or filters could also be provided in the line 16 for particulate matter or the like.

Although produced water from a wellhead or other ground source may have sufficient latent geothermal heat for the humidification/dehumidification process that is to take place in the unit 12, if additional heat, as measured for example by the sensor 20 in the line 16 and the sensor 35 in the line 25, is needed, the holding tank 18 can be provided with a heat exchanger as illustrated, which includes the cold medium return line 21, a source of heat 22, such as a solar collector, and a hot medium supply line 23. The currently preferred temperature range of the produced water that is to be supplied to the humidification/dehumidification unit 12 is 140-212° F., depending, among other factors, upon the humidity of the ambient air.

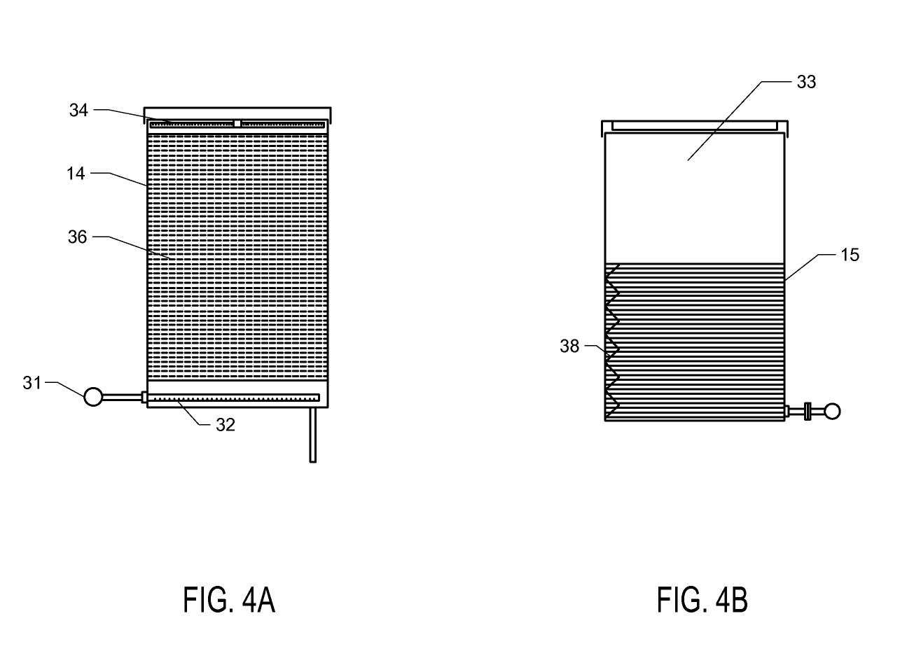

Hot water from the holding tank 18 is subsequently conveyed via the line 25, with the aid of a transfer pump 26, to the humidification/dehumidification unit 12, and in particular a distribution manifold 27, which is covered by a removable lid 28. By means of the distribution manifold 27, the heated produced water is conveyed to the tops of the humidification chamber portions 14, for example by being dripped onto the portions 14 from the top. To aid in the distribution of the water to the humidification chamber portions 14, deflectors 33 can be provided in the lid 28. In addition, a wier 34, such as a v-notched wier, or a similar obstruction, can be provided in the lid 28 above the humidification chamber portions 14, as shown in particular in FIGS. 2 and 3. At the same time, ambient air is blown up into the humidification chamber portions 14 from the bottom as indicated by the blower 30, the air supply conduit 31 and the apertured air induction tubes 32 (see also FIG. 4a).

Thus, the heated water introduced into the humidification chamber portion 14 from the top, and the air introduced into the humidification chamber portion 14 from the bottom, encounter one another in a counter current manner, whereby as the air meets the heated produced water, the capacity of the air to carry water increases, and the water is evaporated while the air becomes humid. To increase residence time of the air and the produced water in the humidification chamber portion 14, packing material 36 can be disposed in the chamber portion 14, as illustrated in particular in FIGS. 1, 3 and 4a. By way of example only, the packing material 36 can be CELdek Media, excelsior (for example as used in evaporative cooler pads) or similar material that retains water. Concentrated produced water is then withdrawn from the bottom of the humidification chamber portion 14, as indicated by reference numeral 37 in FIG. 1, while the now very humid air is pushed into the dehumidification or condensation portion 15. In one specific embodiment of Applicant's system, about 20% of the produced water that was input into the humidification chamber 14 becomes air vapor. The remaining 80% of the input produced water is drained from the bottom of the humidification chamber 14, as indicated above, for example with the aid of the transfer pump 39. This withdrawn, now concentrated, produced water can be reheated and sent back through the system, or can be stored for disposal as a more concentrated yet reduced volume waste water stream.

The humidified air is introduced into the top of the dehumidification chamber 15. As this air drops through the chamber portion 15, it loses heat. This effect can be accentuated by disposing Z-coils 38 in the dehumidification chamber portion 15, whereby the heat removed via the Z-coils 38 is available for return to the humidification chamber 14, or for other purposes. As the air cools in the dehumidification chamber portion 15, it loses its ability to hold as much water, resulting in dehumidification of the air, as a consequence of which fresh water “rains down” or is condensed in the dehumidification chamber portion 15. This very clean water is collected at the bottom of the chamber portion 15, such as in a collection vessel 40. In one specific embodiment, the clean water yield in the vessel 40 is approximately 10% of the produced water volume input into the humidification chamber portion 14.

The clean water collected in the vessel 40 can be withdrawn, for example at a low point drain indicated by the reference numeral 41. In addition, to further increase the yield of Applicant's process, the still somewhat moist air from the dehumidification chamber portion 15 can be passed through the air-cooled condenser or refrigeration unit 43 to further chill the air and thus release more fresh water. In one specific embodiment, this increased the total clean water yield to about 20% of the originally input produced water volume. The clean water from the collection vessel 40, as well as the clean water from the refrigeration unit 43, can be stored in the storage tank 44. When needed for various purposes, the water can be conveyed from the storage tank 44, for example via the transfer pump 45 and the check valve 46.

In order to monitor some of the operating parameters of Applicant's system, as mentioned above temperature sensors 20 and 25 can be provided in the supply lines 16 and 25 respectively. In addition, water level sensors 48 can be provided, for example to monitor the level of the concentrated produced water in the humidification chamber portions 14.

Although in the illustrated embodiment, the humidification chamber portions 14 and the dehumidification chamber portions 15 are shown as alternating with one another, any desired order or disposition of the chamber portions 14 and 15 is possible. Furthermore, whereas six dehumidification chamber portions 15 and five humidification chamber portions 14 are shown, the number of these chamber portions can be varied in any desired fashion.

It should be furthermore noted that Applicant's system is not sensitive to the quality of the input produced water. For example, produced water containing 400,000 ppm of dissolved solids (which is 13-14 times saltier than sea water) has been utilized without encountering any loss of efficiency.

The present invention is, of course, in no way restricted to the specific disclosure of the specification and drawings, but also encompasses any modifications within the scope of the appended claims.

1. A method of purifying produced water, including the steps of:
providing produced water that is at a temperature of from 140 to 212° F.;
conveying the hot water through at least one humidification chamber portion;
conveying ambient air through the at least one humidification chamber portion countercurrent to the direction of conveyance of the hot water therethrough to produce an 99% humid atmosphere in the at least one humidification chamber portion, wherein concentrated produced water is also produced in the at least one humidification chamber portion;
withdrawing the concentrated produced water from the at least one humidification chamber portion;
conveying the humid air of the up to 99% humid atmosphere to at least one dehumidification/condensation chamber portion;
allowing the humid air to cool in the at least one dehumidification/condensation chamber portion, wherein fresh water is condensed out; and
collecting the fresh water.

2. The method of claim 1, wherein the step of providing produced water at a temperature from 140 to 212° F. comprises heating the produced water in a heat exchanger.

3. The method of claim 1, wherein the step of conveying the hot water includes introducing the hot water to the top of the at least one humidification chamber portion, and wherein the step of conveying ambient air includes introducing the ambient air to the bottom of the at least one humidification chamber portion.

4. The method of claim 3, wherein the step of introducing the hot water to the top of the at least one humidification chamber portion comprises dripping the hot water onto the top of the at least one humidification chamber portion.

5. The method of claim 1, wherein the step of conveying the humid air comprises conveying the humid air to the top of the at least one dehumidification/condensation chamber portion.

6. The method of claim 1, which includes the further step of conveying still humid air from said at least one dehumidification/condensation chamber portion to a refrigeration chamber unit to condense out additional fresh water for collection.

7. The method of claim 1, wherein the steps of conveying the hot water and conveying ambient air through the at least one humidification chamber portion comprises conveying the hot water and the ambient air through packing material disposed in the at least one humidification chamber portion.

8. The method of claim 1, wherein the step of allowing the humid air to cool includes passing the humid air over Z-coils disposed in the at least one dehumidification/condensation chamber portion.

9. The method of claim 1, wherein the step of providing produced water comprises providing produced water at a temperature of from 180 to 185° F.

10. A system of purifying produced water, comprising:
a humidification/dehumidification unit comprised of: at least one humidification chamber portion capable of receiving hot produced water and, in a countercurrent direction, air; and at least one dehumidification/condensation chamber portion capable of receiving humid air from said at least one humidification chamber portion, wherein concentrated produced water is capable of being withdrawn from said at least one humidification chamber portion, and clean or purified water is capable of being withdrawn from said at least dehumidification/condensation chamber portion.

11. The system of claim 10, which further includes a heat exchanger for providing the hot produced water.

12. The system of claim 11, wherein said heat exchanger includes means for heating a medium for supply to said heat exchanger.

13. The system according to claim 10, wherein said humidification/dehumidification unit includes conduits for introducing the hot water to the top of the at least one humidification chamber portion, and the air to the bottom of the at least one humidification chamber portion.

14. The system according to claim 13, wherein means are provided for dripping the hot water onto the top of the at least one humidification chamber portion.

15. The system of claim 13, wherein said humidification/dehumidification unit includes means for introducing humid air to the top of the at least one dehumidification/condensation chamber portion.

16. The system of claim 10, which further includes a refrigeration unit for receiving still humid air from said at least one dehumidification/condensation chamber portion for condensing out additional clean or purified water.

17. The system of claim 10, wherein packing material is disposed in said at least one humidification chamber portion.

18. The system of claim 10, wherein Z-coils are disposed in said in at least one dehumidification/condensation chamber portion.

19. The system of claim 10, wherein the hot water is at a temperature of from 140 to 212° F.

20. The system of claim 19, wherein the hot water is at a temperature of from 180 to 185° F.
